(19) United States
(12) Patent Application Publication
(10) Pub. No.: US 2024/0283095 A1
(43) Pub. Date: Aug. 22, 2024

(54) ELECTRICAL CONTACT ELEMENT FOR THE ELECTRICAL INTERCONNECTION OF BATTERY CELLS

(71) Applicant: LISA DRÄXLMAIER GMBH, Vilsbiburg (DE)

(72) Inventors: Alexander DEMUND, Wasserburg (DE); Denis DÜZGÜN, Landshut (DE); Robert HOLZMANN, Vilsbiburg (DE); Michael STECKEL, Vilsbiburg (DE)

(73) Assignee: LISA DRÄXLMAIER GMBH, Vilsbiburg (DE)

(21) Appl. No.: 18/581,824

(22) Filed: Feb. 20, 2024

(30) Foreign Application Priority Data
Feb. 20, 2023 (DE) 10 2023 104 129.0

(51) Int. Cl. H01M 50/503; H01M 50/209; H01M 50/505; H01M 50/522

(52) U.S. Cl. CPC H01M 50/503; H01M 50/505; H01M 50/522; H01M 50/209; H01M 2200/101; H01M 2220/20

(57) ABSTRACT

An electrical contact element for the electrical interconnection of battery cells for battery electric vehicles includes an electrically conductive base element that is able to make electrical contact with a first pole of a battery cell and one or more electrically conductive plug-on elements that project from the base element and are able to be bent in a temperature-dependent manner. The one or more plug-on elements, at a first temperature, assume a first bending position in which they are able to be plugged onto a second pole of an adjacent battery cell in order to produce an electrical plug connection. The one or more plug-on elements, at a second temperature that is higher than the first temperature, assume a second bending position in which the plug connection between the one or more plug-on elements and the second pole of the adjacent battery cell is released.

### CROSS-REFERENCE TO RELATED APPLICATION

This application claims priority to and the benefit of DE 10 2023 104 129.0 filed on Feb. 20, 2023. The disclosure of the above application is incorporated herein by reference.

### FIELD

The present disclosure relates to the field of battery cells for battery electric vehicles, and in particular, the present disclosure relates to an electrical contact element for the electrical interconnection of battery cells.

### BACKGROUND

The statements in this section merely provide background information related to the present disclosure and may not constitute prior art.

The batteries of present-day electric and hybrid cars use battery cells with lithium-ion technology to store the electrical energy for the drive. In certain conditions, this type of cell may have a thermal event in which the cell generate more heat than is able to be dissipated, which may impact neighbouring cells.

In one example, sufficient distances may be provided between the cells or cell modules in thermal propagation (TP)-safe batteries. In other examples, it may be possible to use less reactive cells. However, both of these approaches may reduce energy and power density. Furthermore, heat protection materials/films may be used to inhibit the spread of a thermal event between cell modules. These heat protection materials are primarily effective against high radiant heat released by a reactive cell. If the heat is transferred via permanently installed lines, heat protection materials generally have no effect.

### SUMMARY

This section provides a general summary of the present disclosure and is not a comprehensive disclosure of its full scope or all of its features.

The present disclosure provides a concept for inhibiting the propagation of a thermal event, such as a thermal runaway, through the entire battery, in particular without affecting the power density of the battery.

The present disclosure is based on the following considerations. A propagation path is affected by way of serial interconnection of round cells. A “cell crown”, which is described in more detail below, is welded onto the positive pole of the cell. This crown (with the welded cell) is plugged onto the negative pole of the following cell and makes electrical contact therewith. In the case of a thermal event, thermal energy of the reactive cell is transferred via the cell crown and may lead to overheating of the neighbouring cell. In order to inhibit overheating via the electrical contact, the cell crown is designed in such a way that the cell crown spreads out the contact fingers at high temperatures and thus interrupts the electrical and thermal contact with the following cell. Bimetallic compounds are suitable as material for the cell crown.

The present disclosure is an elegant and unique measure to inhibit TP directly at the source of origin. The local effect of the present disclosure allows for a higher packing density of round cells while at the same time providing TP safety.

According to a first aspect, the present disclosure provides an electrical contact element for the electrical interconnection of battery cells for battery electric vehicles, wherein the electrical contact element comprises the following: an electrically conductive base element that is able to make electrical contact with a first pole of a battery cell; and one or more electrically conductive plug-on elements that project from the base element and are able to be bent in a temperature-dependent manner. The one or more plug-on elements, at a first temperature, assume a first bending position in which the one or more plug-on elements are able to be plugged onto a second pole of an adjacent battery cell in order to produce an electrical plug connection. The one or more plug-on elements, at a second temperature that is higher than the first temperature, assume a second bending position in which the plug connection between the one or more plug-on elements and the second pole of the adjacent battery cell is released.

Such an electrical contact element efficiently inhibits the propagation of a thermal event through the entire battery without affecting the power density of the battery in the process. As a result of the base element being in contact with the first pole of the battery cell and the plug-on elements being plugged onto the second pole of the adjacent battery cell, the transfer of the thermal energy to the adjacent battery cell in the event of a thermal event is inhibited, since the plug-on elements, at a second temperature that may be adjusted according to the temperature in the thermal event, release the electrical and thermal contact with the adjacent battery cell.

The electrical interconnection of the battery cells can be a parallel or series interconnection or a combination of a parallel and series interconnection.

According to one form of the electrical contact element, the base element is able to be cohesively connected to the first pole of the battery cell and/or a busbar, wherein the busbar is designed to electrically connect one or more battery cells.

The base element is fixedly connected to the battery cell, and bending of the plug-on elements at the second temperature to release the adjacent battery cell from the battery cell can result from this fixed connection to the battery cell.

According to one form of the electrical contact element, the one or more plug-on elements in the first bending position are able to be plugged both onto the first pole of the battery cell, and onto a first pole or the second pole of the adjacent battery cell in order to produce a plug connection on both sides between the battery cell and the adjacent battery cell. Groups of poles can also be connected. For example, 3 cells to the first pole and 3 cells to the second pole.

The electrical contact element is able to be used in a flexible manner to electrically and thermally connect a plurality of battery cells to one another in a detachable manner.

According to one form of the electrical contact element, the first temperature is below a threshold temperature at which the battery cell changes into a thermal event state, such as below a thermal runaway or thermal event temperature; and the second temperature is above the threshold temperature.

Below the thermal event temperature, the battery cell is fixedly interconnected with the adjacent battery cell. At a temperature above the thermal event temperature the adjacent battery cell is detached from the battery cell involved in the thermal event.

According to one form of the electrical contact element, the base element and the one or more plug-on elements are at least partially formed from a bimetal that is made up of two metals of different coefficients of thermal expansion.

By using the bimetal, the plug-on elements can be bent elegantly and efficiently. The bimetal is a metal strip that includes two layers of different metals lying one above the other. The two layers are cohesively connected to one another or are connected by form-fitting material. On account of the different coefficients of thermal expansion of the metals used, one of the layers expands more than the other, causing the strip to bend.

According to one form of the electrical contact element, the base element and the one or more plug-on elements are formed from the bimetal at least in a transition region in which the one or more plug-on elements project from the base element.

The entire electrical contact element does not have to be formed from the bimetal, because having certain points that react particularly to bending formed from the bimetal is sufficient.

According to one form of the electrical contact element, the bimetal includes a first metal and a second metal, wherein the first metal has a different coefficient of thermal expansion to the second metal; and wherein the first metal is formed on an outer side or an inner side of the contact element only within the transition region. The first metal has a lower coefficient of thermal expansion on the outer side, than on the inner side.

The bimetal only has to be formed from the bimetal within the transition region in which the one or more attachment elements project from the base element. Such configuration allows material to be saved and the remaining areas of the electrical contact element can be manufactured from a different material.

According to one form of the electrical contact element, the one or more plug-on elements are formed from the bimetal and the base element is formed from a third material; and the one or more plug-on elements are joined to the third material of the base element in the transition region.

The plug-on elements, which are responsible for plugging the adjacent battery cell on and detaching the same from the battery cell, can bend particularly well, while the base element can have good stability properties.

According to one form of the electrical contact element, the base element and the one or more plug-on elements are formed from a sheet metal piece.

The electrical contact element can be manufactured easily, for example by way of suitable bending and forming processes of a sheet metal piece, in order to manufacture the base element and the plug-on elements from the raw sheet metal.

According to one form of the electrical contact element, the sheet metal piece is of crown-shaped form and has a round or angular head piece that forms the base element, from which several prongs project in a star shape and form the one or more plug-on elements.

The series and/or parallel interconnection of the battery cells can be carried out efficiently with such a cell crown. The head piece can be fixedly connected to the battery cell, for example via welding to the first pole, while the prongs projecting from the head piece in a star shape can undertake the gripping function in an efficient manner and can be easily bent open when the threshold temperature is reached so as to interrupt the thermal contact with the battery cell.

According to one form, the electrical contact element is in a metastable first state at the first temperature, in which state the one or more plug-on elements are able to be plugged onto the second pole of the adjacent battery cell. The electrical contact element, upon transitioning to the second temperature, assumes a stable second state in which the one or more plug-on elements are no longer able to be plugged onto the second pole of the adjacent battery cell and the electrical contact element can no longer return to the first state.

In the presence of the thermal event state, the bending open of the plug-on elements is no longer reversible since the stable state has been reached. As a result, unintended thermal contact with the adjacent battery cell is reduced as soon as the battery cell is in the thermal event state.

The electrical contact element can therefore form a “clicker”.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A shows a perspective view of the series interconnection of battery cells;

FIG. 1B shows a perspective view of an electrical contact element, according to one form of the present disclosure;

FIG. 1C shows a schematic illustration of the electrical contact element in profile according to one form of the present disclosure;

FIG. 1D shows a top view of an interconnection of two prismatic battery cells according to one form of the present disclosure;

FIG. 1E shows a side view of the interconnection of two prismatic battery cells of FIG. 1D;

FIG. 1F shows a side view of a parallel interconnection of two round cells according to one form of the present disclosure;

FIG. 1G shows a side view of a series interconnection of two battery cells with a plug connection on both sides according to one form of the present disclosure;

FIG. 1H shows a side view of the electrical contact element of FIG. 1B;

FIG. 2 shows a schematic illustration of the thermal and electrical connection via electrical contact elements according to one form of the present disclosure;

FIG. 3A shows a schematic illustration of the structure and mode of action of the electrical contact element according to one form of the present disclosure;

FIG. 3B shows a schematic illustration of the structure and mode of action of the electrical contact element of FIG. 3A;

FIG. 4 shows a schematic illustration of the mode of action of the electrical contact element according to one form of the present disclosure;

FIG. 5A shows a schematic illustration of a second form of the electrical contact element according to the present disclosure;

FIG. 5B shows a schematic illustration of a third form of the electrical contact element according to the present disclosure;

FIG. 5C shows a schematic illustration of a fourth form of the electrical contact element according to the present disclosure;

FIG. 5D shows a schematic illustration of a fifth form of the electrical contact element according to the present disclosure;

FIG. 6A shows a schematic illustration of the mode of action of the electrical contact element according to one form of the present disclosure;

FIG. 6B shows a schematic illustration of the mode of action of the electrical contact element of FIG. 6A;

FIG. 7 shows a top view of an electrical contact element according to one form of the present disclosure.

The figures are merely schematic illustrations and serve only to explain the present disclosure. Elements that are identical or have an identical effect are provided with the same reference signs throughout.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure is described with reference to the drawings, wherein identical reference signs generally relate to identical elements. Numerous specific details are set out for the purposes of explanation in the description that follows in order to provide an in-depth understanding of one or more aspects of the present disclosure. However, it may be obvious to a person skilled in the art that one or more aspects of the present disclosure can be implemented with a lower level of the specific details. In other cases, known structures and elements are illustrated in a schematic form in order to facilitate the description of one or more aspects. It goes without saying that other forms can be used and structural or logical changes can be made without departing from the concept of the present disclosure.

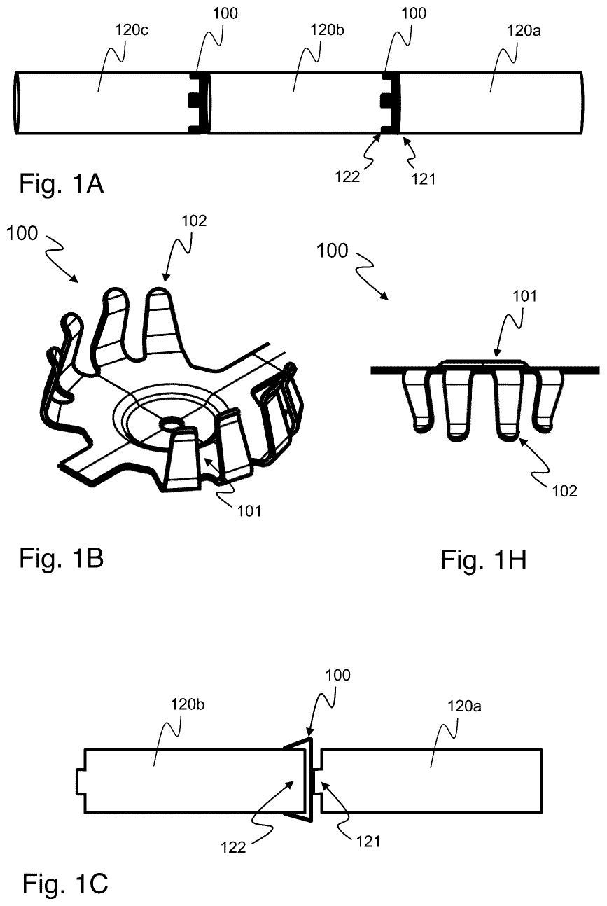

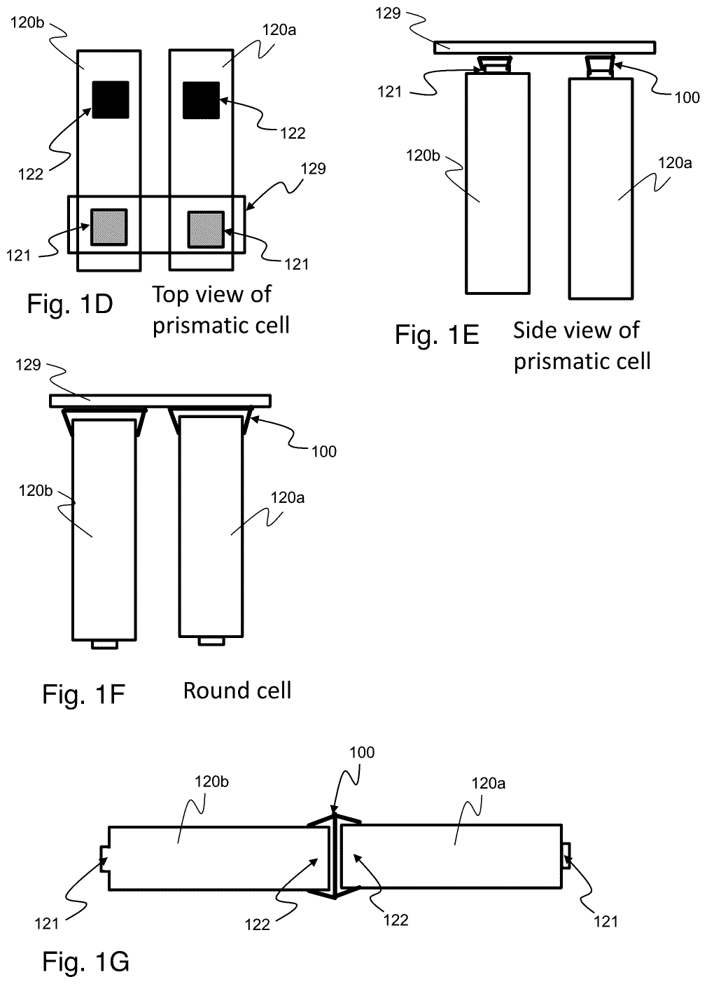

FIG. 1A shows a perspective view of the series interconnection of battery cells, in this case using the example of round cells.

In this example, three battery cells 120a, 120b, 120c are electrically interconnected in series. Each battery cell 120a, 120b, 120c has a positive pole 121 or a first pole 121 and a negative pole 122 or a second pole 122. The series interconnection is affected via electrical contact elements 100, as presented in this disclosure.

The series interconnection of the round cells 120a, 120b, 120c can be affected according to the following scheme: An electrical contact element 100 or a cell crown 100, according to the illustration in FIG. 1B, is welded or otherwise fastened to the positive pole 121 of a round cell 120a (for example, with the format 2170). For the series interconnection, the negative cell pole 122 of a further cell 120b or adjacent cell 120b is inserted into this electrical contact element 100 or cell crown 100 according to the illustration in FIG. 1A. The electrical, mechanical and thermal contact is affected primarily by way of the plug-on elements 102 of the electrical contact element 100 or the contact fingers 102 of the cell crown 100, which press on the negative pole 122 of the adjacent cell 120b. For simplification, the series interconnection is shown according to FIG. 1C.

In this case, the positive pole is referred to as the first pole 121 and the negative pole as the second pole 122. In an alternative form of the cells, the negative pole can also be referred to as the first pole 121 and the positive pole as the second pole 122.

While FIG. 1A shows round cells 120a, 120b, 120c to illustrate the principle in a simplified manner, the electrical contact element 100 presented here can also be used for contacting prismatic cells, which will, however, not be discussed in any more detail below.

FIGS. 1B and 1H show a perspective view and side view of an electrical contact element 100, respectively, according to one form of the present disclosure.

The electrical contact element 100 serves for the electrical, e.g. series and/or parallel interconnection of battery cells 120a, 120b, as shown in FIGS. 1A and 1C, for battery electric vehicles.

The electrical contact element 100 comprises an electrically conductive base element 101 that is able to make electrical contact with a first pole 121 of a battery cell 120a, as shown by way of example in FIGS. 1A and 1C.

The electrical contact element 100 also comprises one or more electrically conductive plug-on elements 102 that project from the base element 101 and are able to be bent in a temperature-dependent manner.

The one or more plug-on elements 102, at a first temperature, assume a first bending position in which they are able to be plugged onto a second pole 122 of an adjacent battery cell 120b in order to produce an electrical plug connection, as shown by way of example in FIGS. 1A and 1C.

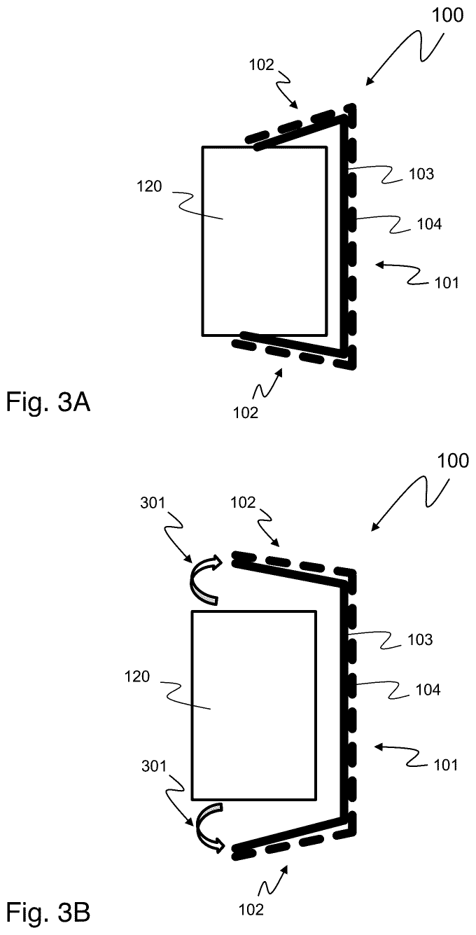

The one or more plug-on elements 102, at a second temperature that is higher than the first temperature, assume a second bending position in which the plug connection between the one or more plug-on elements 102 and the second pole 122 of the adjacent battery cell 120b is released, as shown by way of example in FIGS. 3B, 5C, 5D and 6B.

The base element 101 is able to be cohesively connected to the first pole 121 of the battery cell 120a to create a fixed electrical and thermal contact, for example via a welded or soldered connection.

By way of example, the first temperature is below a threshold temperature at which the battery cell 120a changes into a thermal event state. By way of example, the second temperature is above the threshold temperature. Therefore, the plug-on elements 102 are bent open, and therefore the electrical and thermal contact of the battery cell 120a with the adjacent battery cell 120b is released only when the battery cell is in a predetermined state, i.e. in the thermal event state.

The base element 101 and the one or more plug-on elements 102 can be at least partially formed from a bimetal that is made up of two metals of different coefficients of thermal expansion, as shown in more detail with respect to FIGS. 3A and 3B, for example.

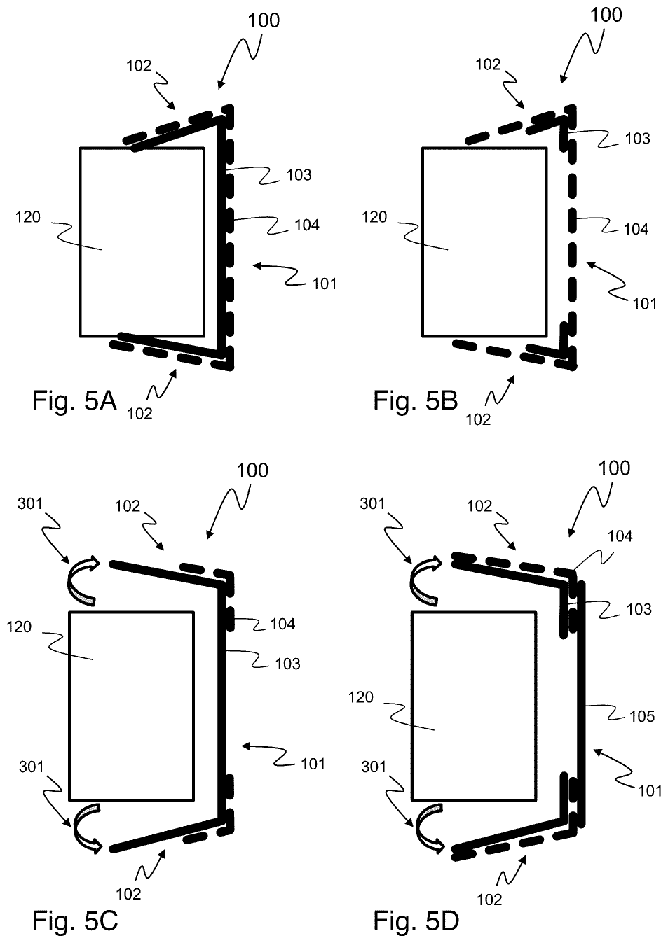

By way of example, the base element 101 and the one or more plug-on elements 102 are formed from the bimetal at least in a transition region in which the one or more plug-on elements 102 project from the base element 101, as shown in more detail in FIGS. 5A to 5D, for example.

The bimetal can include or consist of a first metal 103 and a second metal 104, wherein the first metal 103 has a higher coefficient of thermal expansion than the second metal 104. By way of example, the first metal 103 is formed on an outer side or an inner side of the contact element 100 only within the transition region, as shown in more detail in FIGS. 5B and 5C, for example.

By way of example, the one or more plug-on elements 102 can be formed from the bimetal and the base element 101 can be formed from a third material 105. By way of example, the one or more plug-on elements 102 can be joined to the third material 105 of the base element 101 in the transition region, as shown in more detail in FIG. 5D.

By way of example, the base element 101 and the one or more plug-on elements 102 can be formed from a sheet metal piece.

The sheet metal piece may be of crown-shaped form and have a round or angular head piece that forms the base element 101, from which several prongs project in a star shape and form the one or more plug-on elements 102, as shown in FIG. 1B.

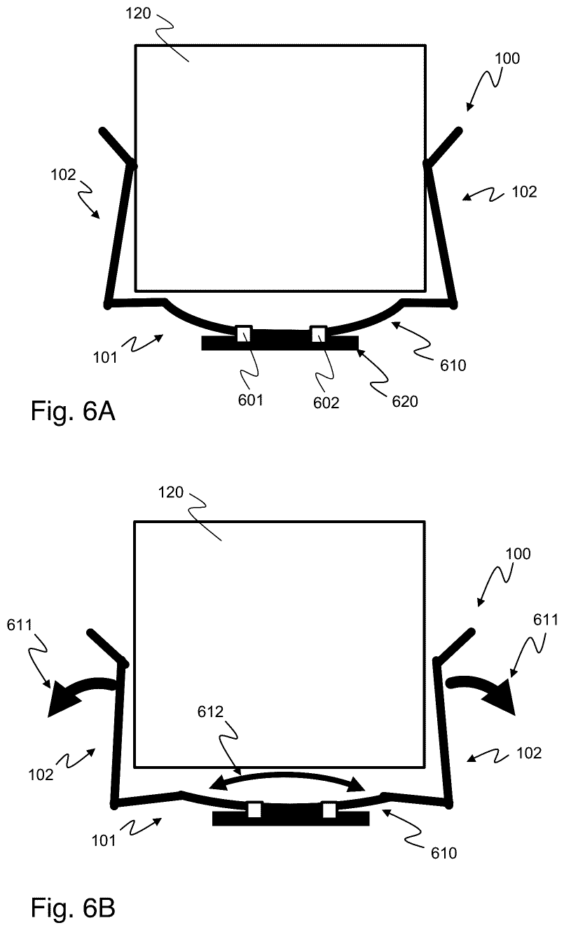

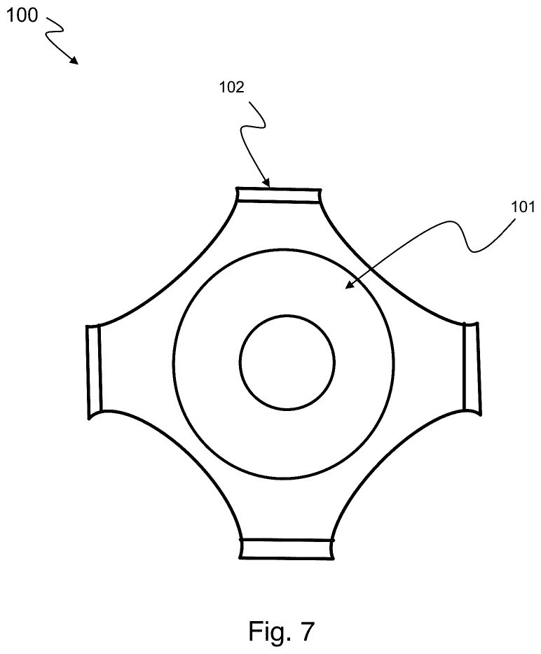

The electrical contact element 100 can be in a metastable first state at the first temperature, in which state the one or more plug-on elements 102 are able to be plugged onto the second pole 122 of the adjacent battery cell 120b. The electrical contact element 100, upon transitioning to the second temperature, can assume a stable second state in which the one or more plug-on elements 102 are no longer able to be plugged onto the second pole 122 of the adjacent battery cell 120b and the electrical contact element 100 can no longer return to the first state, as shown, for example, in FIGS. 6A, 6B and 7.

FIG. 1C shows a schematic illustration of the electrical contact element 100 in profile.

The one or more plug-on elements 102 of the electrical contact element 100, at a first temperature, assume a first bending position in which they are able to be plugged onto the second pole 122 of the adjacent battery cell 120b in order to produce an electrical plug connection. FIG. 1C shows this first bending position. The plug-on elements 102 of the electrical contact element 100 are plugged onto the second pole 122 or negative pole of the adjacent battery cell 120b.

The electrically conductive base element 101 is in electrical contact with the first pole 121 or positive pole of the battery cell 120a, for example via a weld between the base element 101 and the positive pole 121, as shown by way of example in FIG. 1C.

FIG. 1D shows a top view of an interconnection of two prismatic battery cells according to one form.

The prismatic battery cell 120a can be electrically connected to the adjacent prismatic battery cell 120b via a busbar 129, for example interconnected in parallel, as shown in FIG. 1D. The busbar 129 can be plugged onto a first pole 121 of the battery cell 120a and onto a first pole 121 of the adjacent battery cell 120b via an electrical contact element 100. In the same way, the second poles 122 of the two battery cells 120a, 120b can also be connected to one another via a second busbar (not shown). Alternatively, the busbar 129 can also be plugged onto the first pole 121 of the battery cell 120a and the second pole 122 of the adjacent battery cell 120b (not shown).

FIG. 1E shows a side view of the interconnection of two prismatic battery cells of FIG. 1D. In the side view, the way in which the electrical contact element 100 is plugged onto the first poles 121 of the two battery cells 120a, 120b can be seen. By way of example, the base element 101 can be welded to the busbar 129 and the plug-on elements 102 can be plugged onto the poles 121 of the battery cells 120a, 120b in order to produce an electrical and thermal connection.

FIG. 1F shows a side view of a parallel interconnection of two round cells according to one form. In the side view, the way in which the electrical contact element 100 is plugged onto the second poles 122 of the two battery cells 120a, 120b can be seen. The two electrical contact elements 100, which are plugged onto the cells 120a, 120b, are electrically and thermally connected to one another via the busbar 129, for example by a weld. Alternatively, the first poles 121 of the two battery cells 120a, 120b or respectively opposite poles of the two battery cells 120a, 120b can also be connected to one another via the electrical contact elements 100 and the busbar 129, which is not shown here.

By way of example, the base element 101 can be welded to the busbar 129 and the plug-on elements 102 can be plugged onto the poles 121 of the battery cells 120a, 120b in order to produce an electrical and thermal connection.

FIG. 1G shows a side view of a parallel interconnection of two battery cells with a plug connection on both sides according to one form. In this example, the electrical contact element 100 comprises plug-on elements 102, which point in both directions in order to connect the two battery cells 120a, 120b in parallel with one another.

The plug-on elements 102 in the first bending position can be plugged both onto the second pole 122 of the battery cell 120a and onto the second pole 122 or a first pole 121 of the adjacent battery cell 120b in order to produce a plug connection on both sides between the battery cell 120a and the adjacent battery cell 120b.

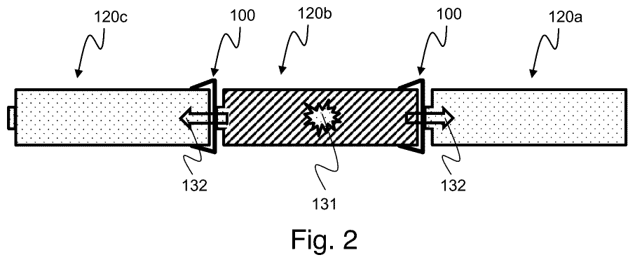

FIG. 2 shows a schematic illustration of the thermal and electrical connection via electrical contact elements 100 according to the present disclosure.

What is shown is an arrangement of round cells as can be used in electric and hybrid vehicles. The cells 120a, 120b, 120c can be arranged in a plurality of axial rows, wherein the positive pole 121 of a cell 120a, 120b, 120c is always connected to the negative pole 122 of the next cell 120a, 120b, 120c. The neighbouring cells 120a, 120c are heated via the thermal contact of the electrical contact element 100, or the cell crown 100, with the cell 120b. In this example shown in FIG. 2, the middle cell 120b changes to the thermal event state 131 and becomes hot. The two outer cells 120a, 120c are heated by way of the thermal contact 132, via the electrical contact element 100, or the cell crown 100, with the middle cell 120b.

In the case of a thermal event, heat 132 is transferred from the reactive cell 120b to the neighbouring cells 120a, 120c via the series electromechanical contact, as shown in FIG. 2. Furthermore, high electric currents flow through the cell 120b and the neighbouring cells 120a, 120c, which can lead to further heating and overcharging of neighbouring cells 120a, 120c. These thermal and electrical effects can lead to a thermal event of the neighbouring cells 120a, 120c.

In order to counteract the effect of heating and overcharging of neighbouring cells, the cell crown 100 can release the contact with the negative pole of the neighbouring cell 120a, 120c at high temperatures. This function can be achieved by virtue of the cell crown 100 being made up of bimetal.

FIGS. 3A and 3B show a schematic illustration of the structure and mode of action of the electrical contact element 100, according to one form of the present disclosure.

FIG. 3A shows the first bending position, which the plug-on elements 102 assume at the first temperature below a thermal event state of the cell 120, and FIG. 3B shows the second bending position, which the plug-on elements 102 assume at the second temperature above the thermal event state of the cell 120.

By way of example, FIG. 3A shows a bimetallic cell crown 100, comprising a first metal 103 and a second metal 104 at room temperature (RT), and having electrical contact with the cell 120. FIG. 3B shows the bimetallic cell crown 100 at a significantly higher temperature, T>>RT, without electrical contact with the cell 120. The increased temperature leads to the bending open 301 of the cell crown fingers 102.

The electrical contact element 100, or the cell crown 100, can be entirely or in part made up of two different metals (bimetal). The two metals are connected directly to one another and have different coefficients of thermal expansion. Similar to the principle of a bimetallic thermometer, the component changes shape depending on temperature. In this case, the metals are arranged such that the contact fingers 102 of the cell crown 100 and the plug-on elements 102 of the electrical contact element 100 bend outwards when heated strongly.

FIG. 3A shows a contacted cell during normal operation. The electrical contact between cell 120 and cell crown 100 is produced. In the case of a thermal event of a cell 120, the cell crown 100 is heated. At increased temperature, the cell crown 100 changes shape and the contact fingers 102 are bent away from the cell 120 (see FIG. 3B). The electromechanical contact with the neighbouring cell is released as a result of this bending. This interrupts the flow of current and flow of heat from the effected cell 120 to the neighbouring cells. The neighbouring cells are no longer heated or charged and can therefore no longer undergo a thermal event.

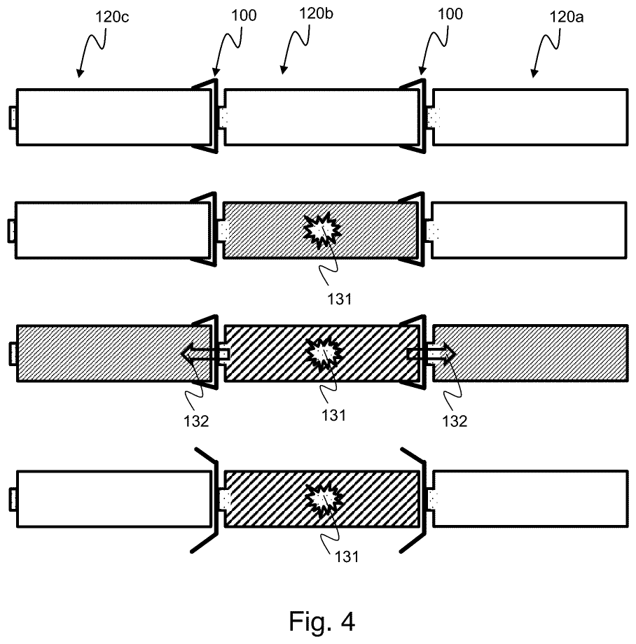

FIG. 4 shows a schematic illustration of the mode of action of the electrical contact element 100, according to one form of the present disclosure.

The initial state of the battery cells 120a, 120b, 120c interconnected in series is shown in the top row. The battery cells 120a, 120b, 120c are connected in series with one another via the electrical contact elements 100, or cell crowns 100, as described above.

The way in which the middle cell 120b changes to the thermal runaway state 131 is shown in the second row. The two neighbouring cells 120a, 120c have not yet been affected thereby.

The way in which the two neighbouring cells 120a, 120c slowly heat up by way of the thermal connection 132 (via the cell crowns 100) to the cell 120b is shown in the third row. Furthermore, current can flow through the cell 120b in the thermal event state 131 by way of the series interconnection and further heat it up.

Finally, the way in which in the plug-on elements 102 of the electrical contact elements 100 are released and interrupt the thermal connection 132 to the neighbouring cells 120a, 120c is shown in the last row. The open cell crowns 100 interrupt the transfer of heat. The separation of the electrical contact due to the cell crowns 100 bending open inhibits further heating of the neighbouring cells 120a, 120c. In this way, the propagation of the thermal event state 131 to the neighbouring cells 120a, 120c is inhibited.

FIGS. 5A, 5B, 5C and 5D show schematic illustrations of alternative forms of the electrical contact element 100 according to the present disclosure.

The mode of operation of the bimetallic cell crown 100 can be implemented in different ways, as shown in FIGS. 5A to 5D.

FIG. 5A shows the structure of the bimetallic cell crown 100. The entire cell crown 100 includes or consists of the bimetallic material pairing.

FIG. 5B shows an alternative structure of the bimetallic cell crown 100. The material pairing is attached locally, for example in the bends of the hollow of the knee of the contact fingers 102.

FIG. 5C shows an alternative structure of the bimetallic cell crown 100. The material pairing is attached locally, for example, to the bends of the knee of the contact fingers 102.

FIG. 5D shows an alternative structure of the bimetallic cell crown 100. The contact fingers 102 includes or consist of the material pairing and are joined to a third material 105.

FIGS. 6A and 6B show a schematic illustration of the mode of action of the electrical contact element 100, according to one form of the present disclosure.

In this example the electrical contact element 100 is in a metastable first state at the first temperature, in which state the one or more plug-on elements 102 are plugged onto the second pole 122 of the adjacent battery cell 120, as shown in FIG. 6A. The electrical contact element 100, upon transitioning to the second temperature, assumes a stable second state, as shown by way of example in FIG. 6B, in which the one or more plug-on elements 102 are no longer able to be plugged onto the second pole 122 of the adjacent battery cell 120 and the electrical contact element 100 can no longer return to the first state.

In this case, the electrical contact element 100 can be in the form of a cell connector with a bimetallic effect and clicker or snap-action disc.

The clicker is a spring that comprises or consists of a strip of spring steel. The steel is formed in such a way that the steel has a stable and a metastable state. The metastable state is stable with respect to small changes, but unstable with respect to major changes. The steel is bent by the action of force until the steel suddenly passes through the metastable state as a result of buckling. The sudden spring to a different state at this point produces the loud clicking noise, which gives the clicker its name. If the force eases back off, a spring back occurs, upon which a loud clicking is produced again. A similar application is snap-action discs, which should have a perceptible pressure point.

In this case, the clicker spring is also the contact-making component and is called the snap-action disc.

As soon as the temperature changes to the predetermined state, the plug-on elements 102 extend outwards 611 and release the connection to the cell 120. The electrical contact element 100 can, in this case, be a clicker or a snap-action disc 610, which, upon transitioning to the state in which the electrical contact element 100 is released from the cell 120, maintains this state by adopting a stable bend 612 of the base element 101 and the plug-on elements 102 and can no longer return to the original contacting state.

Despite a drop in the temperature, the cell connector 100 maintains its geometry due to the clicker.

In this form too, the positive pole 620 of the adjacent cell (not shown in FIGS. 6A and 6B) can be connected to the clicker or base element 101 via welds 601, 602.

FIG. 7 shows a perspective view of an electrical contact element 100, according to one form of the present disclosure.

In this form, the electrical contact element 100 has an electrically conductive base element 101 and an exemplary number of four plug-on elements or fingers 102. By way of example, the electrical contact element 100 is in this case realized as a clicker, which, upon a transition to the released state of the plug-on elements 102 that takes place once, maintains this state despite the drop in temperature, as described above with respect to FIGS. 6A and 6B.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electrical contact element for an electrical interconnection of battery cells for battery electric vehicles, the electrical contact element comprising:
an electrically conductive base element that is configured to make electrical contact with a first pole of a battery cell; and
one or more electrically conductive plug-on elements that project from the base element and are configured to be bent in a temperature-dependent manner, and the one or more plug-on elements, at a first temperature, have a first bending position in which the one or more plug-on elements are configured to be plugged onto a second pole of an adjacent battery cell to produce an electrical plug connection, and the one or more plug-on elements, at a second temperature that is higher than the first temperature, have a second bending position in which the plug connection between the one or more plug-on elements and the second pole of the adjacent battery cell is released.

2. The electrical contact element according to claim 1, wherein the base element is configured to be cohesively connected to at least one of the first pole of the battery cell, and a busbar, and the busbar is configured to electrically connect one or more battery cells.

3. The electrical contact element according to claim 1, wherein the one or more plug-on elements in the first bending position are configured to be plugged onto the first pole of the battery cell and onto a first pole or the second pole of the adjacent battery cell in order to produce a plug connection on both sides between the battery cell and the adjacent battery cell.

4. The electrical contact element according to claim 1, wherein the first temperature is below a threshold temperature at which the battery cell changes into a thermal event state; and wherein the second temperature is above the threshold temperature.

5. The electrical contact element according to claim 1, wherein the base element and the one or more plug-on elements are at least partially formed from a bimetal that includes two metals of different coefficients of thermal expansion.

6. The electrical contact element according to claim 5, wherein the base element and the one or more plug-on elements are formed from the bimetal at least in a transition region in which the one or more plug-on elements project from the base element.

7. The electrical contact element according to claim 6, wherein the bimetal comprises a first metal and a second metal, the first metal has a different coefficient of thermal expansion than the second metal and the first metal is formed on an outer side or an inner side of the electrical contact element within the transition region.

8. The electrical contact element according to claim 7, wherein the one or more plug-on elements are formed from the bimetal and the base element is formed from a third material, and the one or more plug-on elements are joined to the third material of the base element in the transition region.

9. The electrical contact element according to claim 1, wherein the base element and the one or more plug-on elements are formed from a sheet metal piece.

10. The electrical contact element according to claim 9, wherein the sheet metal piece is of crown-shaped form and has a round or angular head piece that forms the base element, from which several prongs project in a star shape and form the one or more plug-on elements.

11. The electrical contact element according to claim 1, wherein the electrical contact element is in a metastable first state at the first temperature in which the one or more plug-on elements are configured to be plugged onto the second pole of the adjacent battery cell, and the electrical contact element, upon transitioning to the second temperature, assumes a stable second state in which the one or more plug-on elements are no longer configured to be plugged onto the second pole of the adjacent battery cell and the electrical contact element is configured to no longer return to the first state.
